(19) United States
(12) Patent Application Publication
(10) Pub. No.: US 2015/0371807 A1
(43) Pub. Date: Dec. 24, 2015

(54) SURFACE IONIZATION SOURCE

(71) Applicant: SMITHS DETECTION MONTREAL INC., Mississauga (CA)

(72) Inventors: Jan Hendrikse, Mississauga (CA); Vladimir Romanov, Vaughan (CA)

(73) Assignee: SMITHS DETECTION MONTREAL INC., Mississauga, ON (CA)

(21) Appl. No.: 14/764,834

(22) PCT Filed: Jan. 30, 2014
(86) PCT No.: PCT/CA14/50058

§ 371 Date: Jul. 30, 2015

Related U.S. Application Data
(60) Provisional application No. 61/788,931, filed on Mar. 15, 2013.
(60) Provisional application No. 61/759,030, filed on Jan. 31, 2013.

(51) Int. Cl. H01J 27/26; H01J 49/26; H01J 49/16

(52) U.S. Cl. CPC H01J 27/26; H01J 49/16; H01J 49/26

(57) ABSTRACT

A surface ionization source comprises a tube having a first end, a second end, and an interior bore extending through the tube from the first end to the second end. The first end of the tube is configured to receive a flow of gas and the second end of the tube is configured to direct the flow of gas onto a surface configured to hold an analyte. A radioactive source is at least substantially disposed in the interior bore of the tube. The radioactive source is configured to form ions in the flow of gas as the flow of gas passes through the interior bore. The flow of gas containing the ions is directed onto the analyte to at least partially ionize the analyte.

### CROSS-REFERENCE TO RELATED APPLICATIONS

This application claims the benefit of U.S. Provisional Application No. 61/759,030, filed Jan. 31, 2013, titled “SURFACE IONIZATION SOURCE,” which is herein incorporated by reference in its entirety, and this application claims the benefit of U.S. Provisional Application No. 61/788,931, filed on Mar. 15, 2013, titled “SURFACE IONIZATION SOURCE,” which is herein incorporated by reference in its entirety.

### BACKGROUND

Various techniques have been developed to create ions directly from a surface. Example techniques include desorption electrospray ionization (DESI) and Direct Analysis in Real Time (DART). However, such surface ionization techniques all create ions by applying a high voltage to a flow of gas. The use of high voltage ionization techniques requires detection equipment employing the ionization sources to employ appropriately rated wiring, high voltage (HV) power supplies, and so forth. Moreover, most high voltage ion sources require the use of consumable liquids or gases to function properly. The use of such consumables can be a. disadvantage when the source is to be used in a hand held device, such as a portable detection device.

### SUMMARY

A surface ionization source that uses radiation to create ions is described. In embodiments, the surface ionization source comprises a tube having a first end, a second end, and an interior bore extending through the tube from the first end to the second end. The first end of the tube is configured to receive a flow of gas and the second end of the tube is configured to direct the flow of gas onto a surface configured to hold an analyte. A radioactive source is at least substantially disposed in the interior bore of the tube. The radioactive source is configured to form ions in the flow of gas as the flow of gas passes through the interior bore. The flow of gas containing the ions is directed onto the analyte to at least partially ionize the analyte. In embodiments, the surface ionization source may be employed by a detection device that comprises an analysis instrument such as a spectrometry analysis instrument configured to receive at least a portion of the ionized analyte for analysis of the analyte.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. The use of the same reference numbers in different instances in the description and the figures may indicate similar or identical items,

FIG. 1 is a block diagram illustrating a surface ionization source in accordance with an example embodiment of the present disclosure.

FIG. 2 is a block diagram illustrating a detection device employing the surface ionization source shown in FIG. 1, in accordance with an example embodiment of the present disclosure.

FIG. 3 is a block diagram illustrating a detection device that includes a surface ionization source having a heating apparatus configured to heat the flow of gas entering the tube of the surface ionization source, in accordance with an example embodiment of the present disclosure.

FIG. 4 is a block diagram illustrating a detection device that includes a surface ionization source and ion transmission assemblies configured to control the movement of at least some of the ions in the flow of gas, in accordance with an example embodiment of the present disclosure.

FIG. 5 is a flow diagram illustrating a method for creating ions using a radioactive source for use in the analysis of an analyte in accordance with an example disclosure.

### DETAILED DESCRIPTION

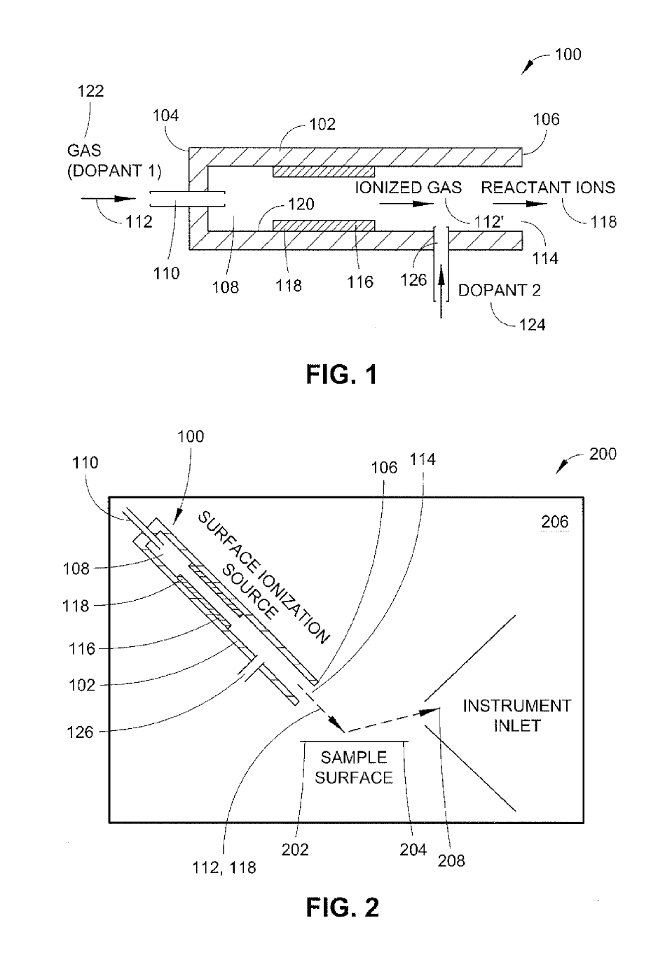

FIGS. 1 through 4 illustrate a surface ionization source 100 in accordance with an embodiment of the present disclosure. As shown in FIG. 1, the surface ionization source 100 includes a tube 102 having a first (inlet) end 104 and a second (outlet) end 106. An interior bore 108 extends through the tube from the first end 104 to the second end 106. The first end 104 of the tube 102 includes an inlet 110 that is configured to receive a flow of gas 112, which flows through the interior bore 108 to the second end 106. The second end 106 includes an outlet (nozzle) 114 that is configured to direct the flow of gas 112 from the tube 102 (e.g., onto a surface 202 configured to hold an analyte 204 (see FIG, 2)). In embodiments, the tube 102 may be fabricated of a material capable of blocking (e.g., reflecting and/or absorbing) radiation (e.g., high energy (Beta) particles, and so forth). Example materials include, but are not limited to: metals such as steel, bronze, aluminum, etc., a plastic, a composite, and so forth. It is contemplated that the tube 102 may also be fabricated of a non-radiation blocking material having a radiation blocking liner disposed therein.

A radioactive source 116 is disposed within the interior bore 108 of the tube 102. The radioactive source 116 is configured to form reactant ions 118 in the flow of gas 112 as the flow of gas 112 passes through the interior bore 108 past the radioactive source 116. More specifically, reactant ions 118 are formed by interaction of the gas 112 with the ionizing radiation emitted by radioactive source 116, which emits high energy particles (e.g., Beta particles). In embodiments, the radioactive source 116 comprises a film 118 emitting high energy particles (e.g., Beta particles) disposed on a surface 120 of the interior bore 108 of the tube. The film 120 may be generally ring-shaped, having an outer diameter generally equal to the diameter of the interior bore 108. The radioactive source if fabricated of a material emitting ionizing radiation comprising high energy particles (e.g., Beta particles). Example materials include, but arc not necessarily limited to: Nickel-63 (Ni-63) or Americium-241 (Am-241).

The flow of gas 112 (e.g., ionized gas 112′) containing reactive ions 118 is directed onto an analyte to at least partially ionize the analyte. The gas employed to furnish the flow of gas 112, through the interior bore 108 of the tube 102 may be any suitable gas. In embodiments, the gas comprises air or dried air, which is readily available. However, it is contemplated that a variety of other gases, such a Nitrogen (N), argon (Ar), and so forth, may be used as the gas employed to furnish the flow of gas 112.

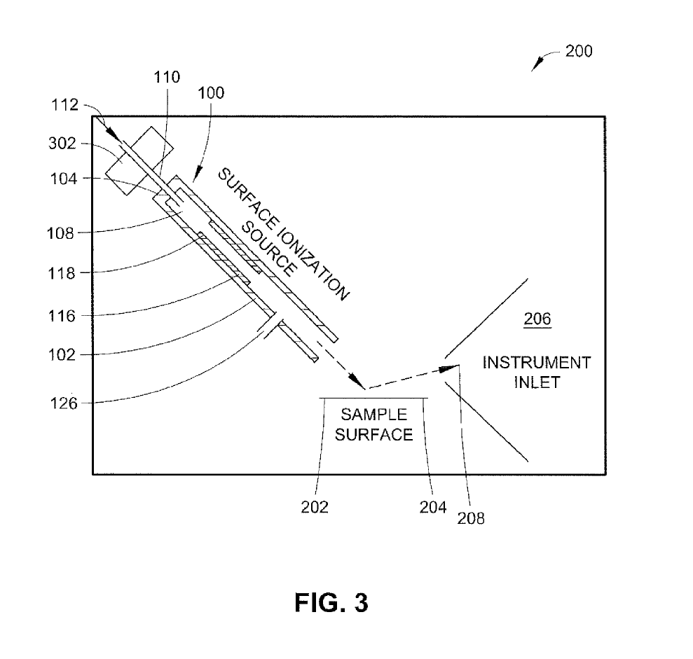

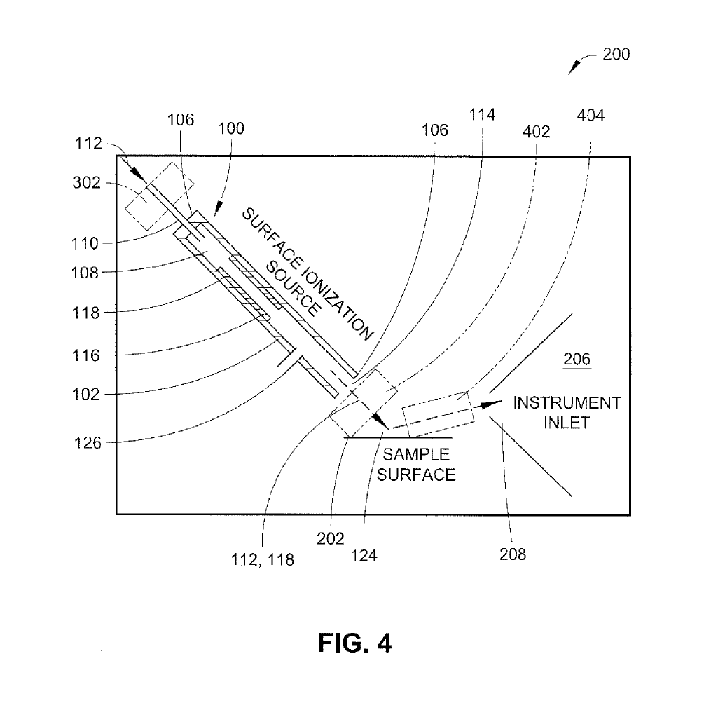

In embodiments, the flow of gas 112 may be heated. For example, as shown in FIGS. 3 and 4, the surface ionization source 100 can include a heat source 302 coupled to the inlet 104 of the tube 102 to heat the flow of gas 112 prior to ionization by (e.g., upstream of) the radioactive source 116. In embodiments, the heat source 302 may comprise a heater block coupled with the inlet 104. In a specific example, the heater block may be configured to heat the flow of gas 112, which may be dry air, to a temperature of 130C. However, the flow of gas 112 may be unheated (e.g., may be approximately the ambient temperature of the environment in which the detection device 200 is operated).

In embodiments, one or more dopants (e.g., “Dopant 1” 122, “Dopant 2” 124) can be added to the flow of gas 112. For example, one or more dopants (e.g., “Dopant 1” 122) may be added to the flow of gas 112 prior to ionization (e.g., upstream of the radioactive source 116) to create a specific ion that reacts to form detectable ions with the analyte(s) of interest (e.g., on the surface 202 FIG. 2). In embodiments, one or more dopants (e.g., “Dopant 1”) 122) may be injected into the flow of gas 112 upstream of the inlet 110 of the tube 102 using a suitable dopant injection port such as a septum, or the like (not shown). In other embodiments, one or more dopants (e.g., “Dopant 2” 124) may be added to the flow of gas 112 after ionization (e.g., via a port 126 provided in the tube 102 downstream of the radioactive source 116) in instances where direct ionization of the dopant could lead to unwanted species. Thus, in various embodiments, it is contemplated that dopants may he injected upstream of the radioactive source 116, downstream of the radioactive source 116, or both upstream and downstream of the radioactive source 116.

In implementations, the surface ionization source 100 may be employed by a detection device, which may be a hand-held portable detection device (e.g., a hand held explosives detector), a non-handheld portable detection device (e.g., a chemical detector), or a stationary (laboratory) detection device, and so forth, that comprises a spectrometry analysis instrument configured to receive at least a portion of the ionized analyte for analysis of the analyte.

FIGS. 2 through 4 illustrate example detection devices 200 that employ the surface ionization source 100 shown in FIG. 1, in accordance with an example embodiment of the present disclosure. As shown, the detection devices 200 include a surface 202 that holds an analyte (e.g., a sample to be analyzed) 204 and a spectrometry analysis instrument 206 having an inlet 208 configured to receive at least a portion of the ionized analyte 204 for analysis of the analyte 204. In embodiments, the surface 202 may comprise a non-conductive sample surface such as a glass surface, or the like. However, in other embodiments, the surface 202 can comprise a sample collection swab received by the detection device 200.

The spectrometry analysis instrument 206 may employ any of a number of mass spectrometry techniques including Ion Trap, Quadruple, Time of Flight, Magnetic Sector, Orbitrap, combinations thereof, and so forth, for mass-selection of ions, and/or ion mobility spectrometry techniques such as Ion Mobility Spectrometry (IMS), Field Asymmetric Ion Mobility Spectrometry (FAIMS), Traveling Wave Ion Mobility Spectrometry (TWIMS), Standing Wave IMS, combinations thereof, and so forth for mobility-selection of ions. The ions may be detected by a detector of the spectrometry analysis instrument 206 appropriate for the selection (separation) technique(s) used.

The surface ionization source 100 is positioned so that the second end 106 of the tube 102 (the outlet (nozzle) 114) is placed near the surface 202 containing an analyte 204. For example, as shown, the surface ionization source 100 (e.g., the tube 102) may be positioned so that the flow of gas 112 exiting the outlet (nozzle) 114 impinges the surface 202 at an angle opposite the inlet 208 of the spectrometry analysis instrument 206. The flow of gas 112 containing reactant ions 118 ionizes at least a portion of the analyte, creating analyte ions that are transferred to the spectrometry analysis instrument 200 for analysis.

As shown in FIG. 2, the flow of gas 112 may facilitate transmission of ions from the surface ionization source 100 to the surface 202 and/or to the inlet 208 of the spectrometry analysis instrument 206 for analysis by the device 206. However, transmission of ions from the surface ionization source 100 to the sample surface 202 and/or the inlet 208 of the spectrometry analysis instrument 206 can be enhanced by appropriately shaped flow fields, electric fields, or a combination thereof. Moreover, the use of shaped flow fields and/or electric fields can allow the same source to be used to produce both positive and negative ions from the surface 112. In FIG. 4, the detection device 200 is illustrated as employing one or more ion transmission assemblies 402, 404 configured to control the movement of at least some of the ions in the flow of gas 112. The ion transmission assemblies 402, 404 are configured to generate flow fields, electric fields, or a combination thereof, suitable for transmission of ions from the surface ionization source 100 to the sample surface 202 and/or the inlet 208 of the spectrometry analysis instrument 206.

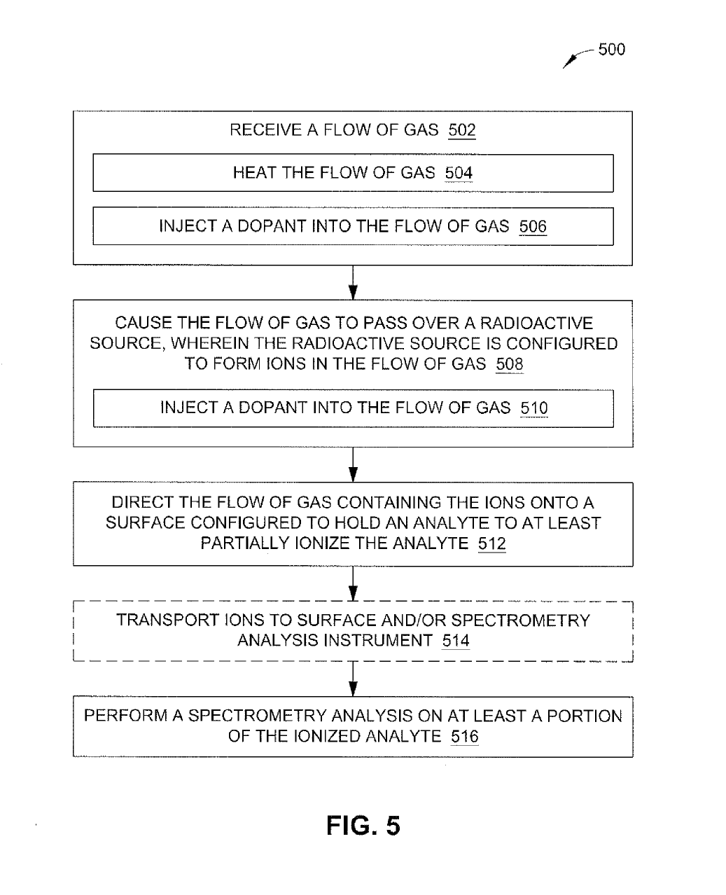

FIG. 5 illustrates a method 500 for creating ions using ionizing radiation from a radioactive source for use in the analysis of an analyte in accordance with an embodiment of the present disclosure. In embodiments, the method 500 may be implemented using a surface ionization source, such as the surface ionization source 100 shown in FIG. 1 by a detection device, such as the detection devices shown in FIGS. 2, 3 and 4.

As shown, a flow of gas is received (Block 502). For example, as discussed herein, a flow of gas may be received by an inlet 110 provided in the first end 104 of the tube 102 of the surface ionization source 100, which flows through the interior bore 108 to the second end 106 of the tube, The gas employed to furnish the flow of gas 112, through the interior bore 108 of the tube 102 may be any suitable gas. In embodiments, the gas comprises air or dried air, which is readily available. However, it is contemplated that a variety of other gases, such a Nitrogen (N), argon (Ar), and so forth, may be used as the gas employed to furnish the flow of gas 112.

In embodiments the flow of gas may be heated (Block 504). For example, as shown in FIGS. 3 and 4, the surface ionization source 100 can include a heat source 302 coupled to the inlet 104 of the tube 102 to heat the flow of gas 112 prior to ionization by (e.g., upstream of) the radioactive source 116. In embodiments, the heat source 302 may comprise a healer block coupled with the inlet 104, However, the flow of gas 112 may be unheated (e.g., may be approximately the ambient temperature of the environment in which the detection device 200 is operated).

A dopant may be injected into the flow of gas (Block 506). For example, one or more dopants (e.g., “Dopant 1” 122) may be added to the flow of gas 112 prior to ionization (e.g., upstream of the radioactive source 116) to create a specific ion that reacts to form detectable ions with the analyte(s) of interest (e.g., on the surface 202 FIG. 2). In embodiments, dopants (e.g., “Dopant 1”) 122) may be injected into the flow of gas 112 upstream of the inlet 110 of the tube 102 using a suitable dopant injection port such as a septum, or the like (not shown).

The flow of gas is then caused to pass over a radioactive source, wherein the radioactive source is configured to form ions in the flow of gas (Block 508). As shown in FIG. 1, the radioactive source 116 is disposed within the interior bore 108 of the tube 102 of the surface ionization source 100. The radioactive source 116 is configured to form reactant ions 118 in the flow of gas 112 as the flow of gas 112 passes through the interior bore 108 past the radioactive source 116. More specifically, reactant ions 118 are formed by interaction of the gas 112 with the ionizing radiation emitted by radioactive source 116, which emits high energy particles (e.g., Beta particles). In embodiments, the radioactive source 116 comprises a film 118 emitting high energy particles (e.g., Beta particles) disposed on a surface 120 of the interior bore 108 of the tube. The film 120 may be generally ring-shaped. having an outer diameter generally equal to the diameter of the interior bore 108. The radioactive source if fabricated of a material emitting ionizing radiation comprising high energy particles (e.g., Beta particles). Example materials include, but are not necessarily limited to: Nickel-63 (Ni-63) or Americium-241 (Am-241).

A dopant may then be injected into the flow of gas (Block 510). For example, one or more dopants (e.g., “Dopant 2” 124) may be added to the flow of gas 112 after ionization (e.g., via a port 126 provided in the tube 102 downstream of the radioactive source 116) in instances where direct ionization of the dopant could lead to unwanted species. Thus, in various embodiments, it is contemplated that dopants may be injected upstream of the radioactive source 116 (Block 506), downstream of the radioactive source 116 (Block 510), or both upstream and downstream of the radioactive source 116 (both Block 506 and Block 510).

The flow of gas containing the ions is directed onto a surface configured to hold an analyte to at least partially ionize the analyte (Block 512). For example, as shown in FIGS. 2 through 4, the flow of gas 112 (e.g., ionized gas 112′) containing reactive ions 118 is directed onto an analyte to at least partially ionize the analyte. In embodiments, the surface 202 may comprise a non-conductive sample surface such as a glass surface, or the like. However, in other embodiments, the surface 202 can comprise a sample collection swab received by the detection device 200.

As noted, the surface ionization source 100 may be positioned so that the second end 106 of the tube 102 (the outlet (nozzle) 114) is placed near the surface 202 containing an analyte 204. For example, as shown, the surface ionization source 100 (e.g., the tube 102) may be positioned so that the flow of gas 112 exiting the outlet (nozzle) 114 impinges the surface 202 at an angle opposite the inlet 208 of the spectrometry analysis instrument 206. The flow of gas 112 containing reactant ions 118 ionizes at least a portion of the analyte, creating analyte ions that are transferred to the spectrometry analysis instrument 200 for analysis.

In embodiments, the ions from the surface ionization source may be transported to the surface and/or to a spectrometry analysis instrument (Block 514) so that a spectrometry analysis can be performed on at least a portion of the ionized analyte (Block 516). In embodiments, such as the embodiment shown in FIG. 2, the flow of gas 112 may facilitate transmission of ions from the surface ionization source 100 to the surface 202 and/or to the inlet 208 of the spectrometry analysis instrument 206 for analysis by the device 206. In other embodiments. such as the embodiment shown in FIG. 4, the detection device 200 is illustrated as employing one or more ion transmission assemblies 402, 404 configured to control the movement of at least some of the ions in the flow of gas 112. The ion transmission assemblies 402, 404 are configured to generate flow fields, electric fields, or a combination thereof, suitable for transmission of ions from the surface ionization source 100 to the sample surface 202 and/or the inlet 208 of the spectrometry analysis instrument 206.

As noted, the spectrometry analysis instrument 206 may employ any of a number of mass spectrometry techniques including Ion Trap, Quadruple, Time of Flight, Magnetic Sector, Orbitrap, combinations thereof, and so forth, for mass-selection of ions, and/or ion mobility spectrometry techniques such as Ion Mobility Spectrometry (IMS), Field Asymmetric Ion Mobility Spectrometry (FAIMS), Traveling Wave Ion Mobility Spectrometry (TWIMS), Standing Wave IMS, combinations thereof, and so forth for mobility-selection of ions. The ions may be detected by a detector of the spectrometry analysis instrument 206 appropriate for the selection (separation) technique(s) used.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A surface ionization source comprising:
a tube having a first end, a second end, and an interior bore extending through the tube from the first end to the second end, the first end configured to receive a flow of gas and the second end configured to direct the flow of gas onto a surface operable to hold an analyte; and
a radioactive source at least substantially disposed in the interior bore of the tube, the radioactive source configured to form ions in the flow of gas as the flow of gas passes through the interior bore, wherein the flow of gas containing the ions is directed onto the analyte to at least partially ionize the analyte.

2. The surface ionization source as recited in claim 1, wherein the radioactive source comprises a film emitting high energy particles disposed on a surface of the interior bore of the tube.

3. The surface ionization source as recited in claim 2, wherein the film is generally ring shaped.

4. The surface ionization source as recited in claims 1 to 3, wherein the radioactive source comprises at least one of Nickel-63 (Ni-63) or Americium-241 (Am-241).

5. The surface ionization source as recited in claims 1 to 4, wherein the flow of gas comprises a flow of dry air.

6. The surface ionization source as recited in claims 1 to 5, further comprising a heat source configured to heat the flow of gas.

7. The surface ionization source as recited in claims 1 to 6, further comprising an ion transmission assembly configured to control the movement of at least some of the ions in the flow of gas.

8. The surface ionization source as recited in claims 1 to 7, further comprising a port configured to facilitate addition of a dopant into the flow of gas.

9. A detection device comprising:
a surface ionization source including a tube having a first end, a second end, and an interior bore extending through the tube from the first end to the second end, the first end configured to receive a flow of gas and the second end configured to direct the flow of gas onto a surface operable to hold an analyte; and a radioactive source at least substantially disposed in the interior bore of the tube, the radioactive source configured to form ions in the flow of gas as the flow of gas passes through the interior bore, wherein the flow of gas containing the ions is directed onto the analyte to ionize the analyte; and
a spectrometry analysis instrument configured to receive at least a portion of the ionized analyte for analysis of the analyte.

10. The detection device as recited in claim 9, wherein the radioactive source comprises a film emitting high energy particles disposed on a surface of the interior bore of the tube.

11. The detection device as recited in claim 10, wherein the film is generally ring shaped.

12. The detection device as recited in claims 9 to 11, wherein the radioactive source comprises at least one of Nickel-63 (Ni-63) or Americium-241 (Am-241).

13. The detection device as recited in claims 9 to 12, wherein the flow of gas comprises a flow of dry air.

14. The detection device as recited in claims 9 to 13, further comprising a heat source configured to heat the flow of gas.

15. The detection device as recited in claims 9 to 14, further comprising an ion transmission assembly configured to control the movement of at least some of the ions in the flow of gas.

16. The detection device as recited in claims 9 to 15, wherein spectrometry analysis instrument comprises at least one of a mass spectrometer or a ion mobility spectrometer (IMS).

17. The detection device as recited in claims 9 to 16, further comprising a port configured to facilitate addition of a dopant into the flow of gas.

18. A method comprising:
receiving a flow of gas;
causing the flow of gas to pass over a radioactive source, the radioactive source configured to form ions in the flow of gas as the flow of gas passes over the radioactive source; and
directing the flow of gas containing the ions onto a surface configured to hold an analyte to at least partially ionize the analyte.

19. The method as recited in claim 18, further comprising performing a spectrometry analysis on at least a portion of the ionized analyte.

20. The method as recited in claim 18 or 19, wherein the radioactive source comprises at least one of Nickel-63 (Ni-63) or Americium-241 (Am-241).

21. The method as recited in claims 18 to 20, further comprising heating the flow of gas.

22. The method as recited in claims 18 to 21, further comprising injecting a dopant into the flow of gas.
